(19) United States
(12) Patent Application Publication
(10) Pub. No.: US 2011/0114398 A1
(43) Pub. Date: May 19, 2011

(54) Battery Power System for Plug In Hybrid Tractor Trailers

(76) Inventor: James S. Bianco, Suffield, CT (US)

(21) Appl. No.: 12/948,082

(22) Filed: Nov. 17, 2010

Related U.S. Application Data
(60) Provisional application No. 61/281,394, filed on Nov. 17, 2009.

(51) Int. Cl. B60K 1/04; H02J 7/00; B60L 11/18

(52) U.S. Cl. 180/65.1; 320/109; 307/9.1; 180/65.29

(57) ABSTRACT

A battery power system for a plug-in hybrid or electric tractor trailer employs a battery module which is carried by the trailer. A cable communicates with the battery module and connects with a connector on the cab for supplying power to power the electric motor of the cab. The cab can be disconnected from the trailer while the battery module on the trailer is charged. The cab can then be driven by the electric motor powered by the battery supply of the cab.

### CROSS-REFERENCE TO RELATED APPLICATION

This application claims the priority of U.S. Provisional Patent Application No. 61/281,394 filed on Nov. 17, 2009, the entirety of which application is incorporated herein by reference.

### BACKGROUND

This disclosure relates generally to electric and plug in hybrid and electric vehicles. More particularly, this disclosure relates to plug in hybrid and electric tractor trailers and methods for adding batteries to new and existing tractors and trailers.

In vehicles and recharging methods to which the disclosure relates, a vehicle derives its motive power from an electrical battery source and also employs an internal combustion engine to provide an auxiliary source of motive power. A number of facilities and techniques have been proposed for periodically charging the battery power supply while the vehicle is in an idle state. The use of battery power for the principal motive force for heavy duty transport, such as tractor trailers, is much more problematic. In order to be effective, the battery power sources must provide relatively large quantities of power. The size and bulk of the battery power packs can be extremely large. It is also necessary to provide a highly efficient system for recharging the battery power supply.

### SUMMARY

Briefly stated, a battery power system for plug in hybrid or electric tractor trailers efficiently addresses the high power requirements for heavy duty transport by plug in hybrid or electric tractor trailers and the efficient recharging of a high capacity battery supplies adapted for usage in plug in hybrid or electric vehicles. The system provides for increased capability of large capacity battery sources by mounting a battery module to the carriage of the trailer. The battery module can then be connected to the plug in hybrid or electric cab to supply electric power to the electric motor of the cab. The power module in the trailer can also be disconnected from the plug in hybrid or electric cab so that the cab may be decoupled from the trailer and employed for other purposes such as retrieving another trailer.

In addition, the battery module may be efficiently charged while the trailer is being unloaded and/or loaded at a loading dock. The system allows for the plug in hybrid or electric cab to be employed in an efficient manner on its own battery power without the trailer. For conditions in which the plug in hybrid or electric cab and trailer are connected for transport, the enhanced power capacity provided by the battery module of the trailer efficiently matches the high power demand for transport loads over significant distances with a corresponding high capacity power supply.

### BRIEF DESCRIPTION OF THE DRAWINGS

FIG. 1 is an elevational view, partly in schematic, of a representative plug in hybrid tractor trailer parked at a loading dock, partially illustrated;

FIG. 2 is a bottom plan view, partly in schematic, of the plug in hybrid tractor trailer of FIG. 1;

FIG. 3 is a side elevational view, partly in schematic, of a representative plug in hybrid tractor trailer at a loading dock illustrating a first step in connection with charging the battery supply;

FIG. 4 is a side elevational view, partly in schematic, of a representative plug in hybrid tractor trailer at a loading dock illustrating a second step in connection with charging the battery supply;

FIG. 5 is a side elevational view, partly in schematic, of a representative plug in hybrid tractor trailer at a loading dock illustrating a third step in connection with charging the battery supply;

FIG. 6 is a side elevational view, partly in schematic, of a representative plug in hybrid tractor trailer at a loading dock illustrating a fourth step in connection with charging the battery supply;

FIG. 7 is a side elevational view, partly in schematic, of a representative plug in hybrid tractor trailer at a loading dock illustrating a fifth step in connection with charging the battery supply; and

FIG. 8 is a top plan view, partly in schematic, of a representative plug in hybrid tractor trailer being charged at a truck stop electrification service tower.

### DETAILED DESCRIPTION

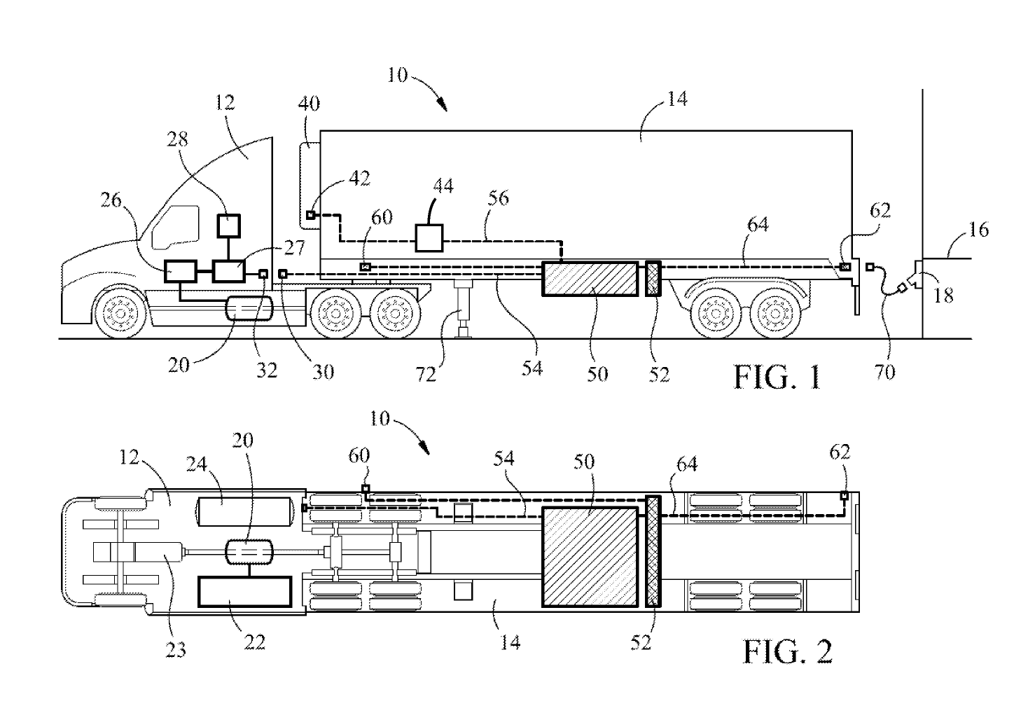

With reference to the drawings wherein like numerals represent like parts throughout the several figures, a plug in hybrid tractor trailer which employs battery power as well as an internal combustion engine for the motive power is generally designated by the numeral 10. The plug in hybrid tractor trailer comprises a plug in hybrid tractor or cab 12 which couples with the trailer 14. In FIG. 1, the tractor trailer is illustrated as parked at a loading dock 16 which also has a power outlet 18. It should be appreciated that the cab 12 and trailer 14 are intended to be representative of various possible types and configurations. The cab 12, in some embodiments, may be powered solely by electricity and not employ an internal combustion engine.

The plug in hybrid cab 12 employs an induction drive motor 20 which obtains power from an onboard battery module 22. In one embodiment, the battery module is disposed opposite the fuel tank 24 for the internal combustion engine. A voltage converter 27 converts the DC battery voltage from either the onboard battery module 22 or a trailer battery module 50 to AC voltage required for the electric motor controller 26 and the cab utilities 28. The battery module 50 on the trailer 14 is connected via a battery power cable connector 30 on the trailer 14 to a battery power connector 32 on the trailer cab 12. The power connector 32 is connected to the DC to AC converter 27.

The trailer 14 carries at its underside the battery module 50. The battery module has a high power capacity and accordingly a substantial weight and bulk, such as, for example, a weight approaching one ton or more. A battery charger 52 for periodically charging the battery module electrically connects with the battery module 50. The battery charger 52 may also be located on loading dock 16. Power outlet 18 would supply DC voltage instead of AC voltage. A DC power out cable 54 leads from the battery module 50 to connect with the battery power connector 32 of the cab. Consequently, it can be seen that a substantial portion of electrical power for the induction driven motor 20 can be provided by the battery module 50 which is carried at the underside carriage of the trailer.

The trailer 14, which in the illustrated embodiment has an electric refrigeration unit (“reefer”) 40, may have numerous forms and functions. The electric refrigeration unit (“reefer”) 40 is powered by a second DC cable 56 which connects from the battery module 50 to the electric refrigeration unit 40 via a DC to AC converter 44 and a connector 42. An AC truck service electrification (“TSE”) inlet or connector 60 is accessible at a frontal side location of the trailer and connects with the battery charger 52. The connector 60 is adapted for connection with power supplied at a service tower. In addition, an AC dock connector 62 is located at the rear of the trailer. The dock connector 62 also connects via a cable 64 with the battery charger 52.

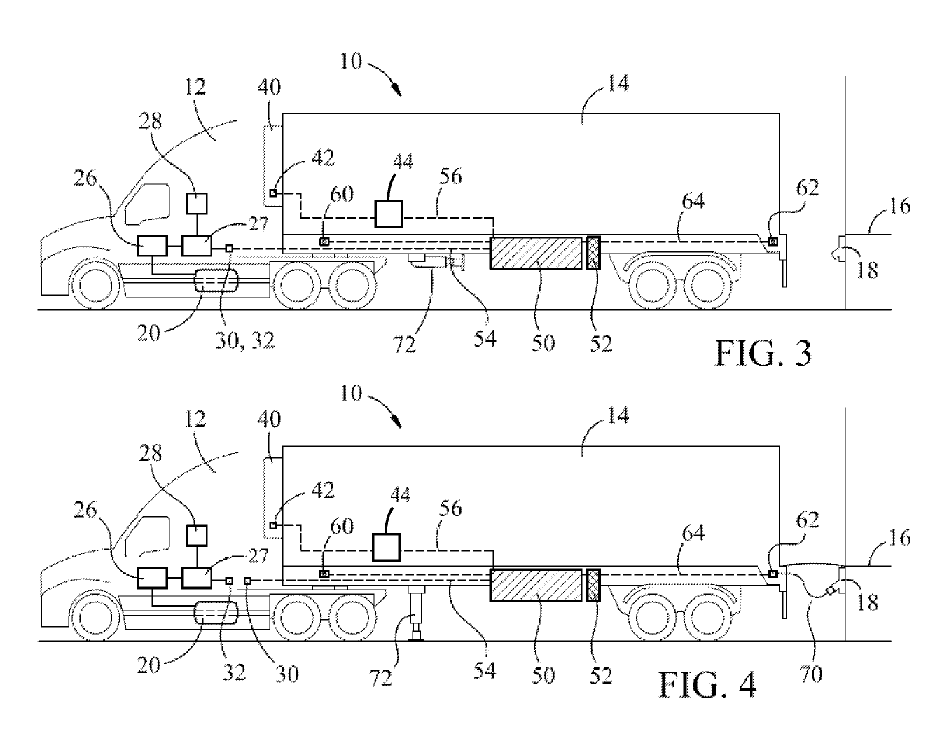

In normal operation for transport of a load in the trailer, the battery power inlet 32 in the cab is connected with the DC battery cable 54 so that electric motive power is provided by both the battery module 50 and the battery module 22 of the cab. This condition is illustrated in FIG. 3 which shows the tractor trailer as it is initially parked at the loading dock 16. While the tractor 12 is connected to the tractor 14 via connector 32 and power cable connector 30, the battery module 22 is being charged by battery module 50. Battery module 22 is also charged by induction drive motor 20 which, when driven by tractor internal combustion engine 23, converts to become a voltage generator.

With reference to FIG. 4, a power extension cable 70 connects the AC outlet connector 62 at the rear of the trailer with a power outlet connector 18 at the loading dock 16. The outlet connector 18 in one embodiment functions as a 480-volt, three-phase connection to provide a substantial high-powered charge to the battery module 50. The battery module 22 of the cab can also be charged in this fashion. However, the battery power connection to the cab from the trailer battery module 50 may also be unplugged or disconnected at power connector 30, and the trailer set on a support jack 72.

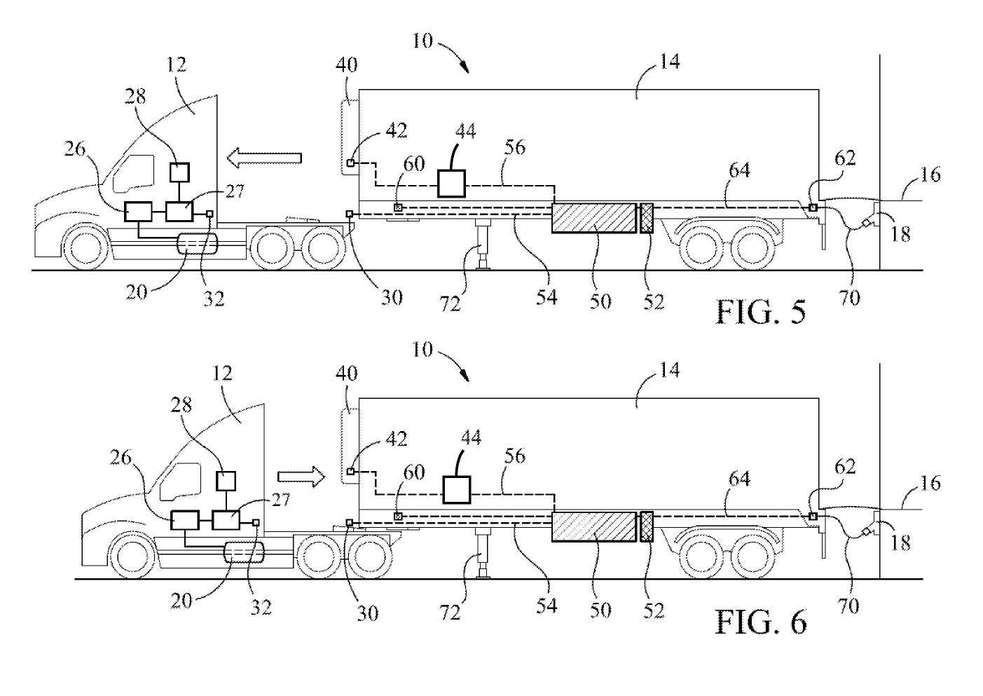

With reference to FIG. 5, the plug in hybrid cab 12 may be uncoupled and then driven away to pickup another trailer. In this operational mode battery power for the plug in hybrid cab 12 is supplied by the battery module 22. It will be appreciated that the plug in hybrid cab 12 of the tractor trailer 10 makes particularly advantageous use of battery power when frequently stopped in traffic or other frequent idle conditions. While the trailer 14 is being loaded, the battery module 50 is being charged via the extension cable 70. The refrigeration unit 40 is operated directly from AC power through cable 64 or from battery module 50.

With reference to FIG. 6, the plug in hybrid cab 12 is then returned to pick up the trailer 14 which may now have been fully charged or partially charged while the trailer was loaded and/or unloaded.

The extension cable 70 is disconnected from the connector 62. The battery power cable 54 is re-connected to the battery power connector 30 of the cab 12. Electricity can now be supplied from the trailer battery module 50 to the motor 20. In a transport mode as schematically illustrated in FIG. 7, the plug in hybrid cab 12 and the trailer 14 are driven away to deliver a load.

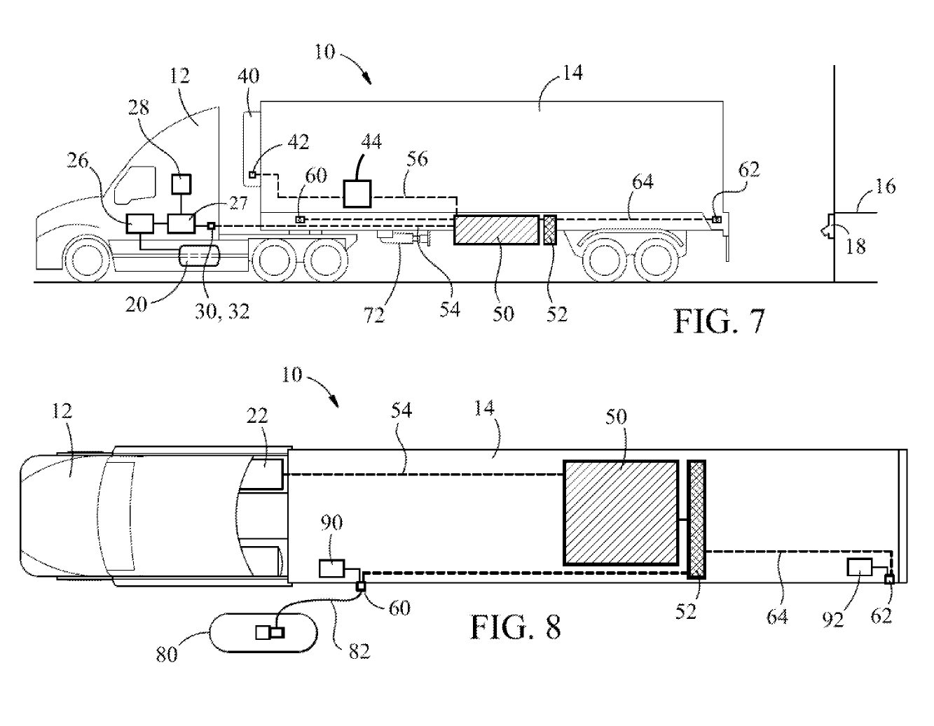

Alternatively, the tractor trailer 10 may be parked at a truck stop electrification service tower 80 as illustrated in FIG. 8. An extension cable 82 connects with the TSE AC inlet connector 60 of the trailer for charging the battery module 50 via the battery charger 52. If the cab remains connected via cable 54, the battery module 22 on the cab may also be charged.

The reefer 40 can either operate off the battery module 50 or AC power when the tractor trailer 10 is parked at truck electrification station 80 and connected with the TSE AC connector 60. The drive motor 20 and/or the internal combustion engine can also be partially employed for recharging of the battery as well as for refrigeration of the refrigeration unit. When the tractor trailer is stopped, the reefer 40 preferably operates off the battery. At a TSE stop, the AC power can be employed to charge the battery module 22 in the cab and the battery module 50 in the trailer, as well as to operate the various cab utilities 28 and power the refer 40.

The plug in hybrid tractor trailer 10 also preferably incorporates a detector 90 and 92 (FIG. 8) at connectors 60 and 62, respectively, which detect whether the associated power cable is plugged in and connected. Signals from the detectors are transmitted to the cab. This feature ensures that the tractor trailer will not be driven away when an extension is connected either at the dock or at the TSE service tower.

Positioning the battery module 50 in the trailer 14 results in several beneficial features. First, the battery module can be physically large and provide a high capacity electrical output to the motor. The substantial bulk and weight of the battery module can be efficiently distributed across the trailer carriage which is ordinarily designed for heavy loads. Second, the significant loading/unloading time of the trailer at the dock can be efficiently exploited to charge the battery which, due to its large capacity, may require a significant time for charging. Third, the plug in hybrid cab 12, when disconnected, can efficiently operate independently on its own battery supply and is especially suitable for local, city and high traffic environments. This independent operation of the plug in hybrid cab can be accomplished while the trailer battery module is being charged. Fourth, in a transport mode when substantial battery power is needed for transport of the trailer over substantial distances, the additional power of the trailer power module 50 can be supplied to the motive motor 20 of the cab. Fifth, because the trailer can carry a heavy battery module, the plug in hybrid tractor trailer 10 can transport a meaningful load under battery power over a significant distance for a relatively long time interval.

Battery modules having different capacities (and also different weight and dimensional constraints) can be provided. A battery power module with a given capacity can be selected and mounted to the trailer for the specific transport function. It will also be appreciated, that by providing the additional high capacity battery module in the trailer, the substantial physical load of the power module can be naturally distributed along the trailer carriage using structure and distribution principles similar to that employed for the load to be transported by the trailer. For some governmental road use regulations, it may be desirable to offset the weight of the battery module 50 in the trailer against the maximum trailer load requirements.

1. A plug in hybrid or electric tractor trailer comprising:
a cab having an electric motor for driving said cab;
a battery power supply to supply power to said electric motor and a controller for controlling power to said electric motor and being in electrical communication with a battery power connector; and
a trailer couplable with said cab for transport by said cab, said trailer carrying a battery module, said module communicating with a battery cable connectable with said cab battery power connector, said battery module communicating with an external connector located on said trailer for external electrical communication.

2. The tractor trailer of claim 1 wherein said external connector is a dock inlet connector.

3. The hybrid tractor trailer of claim 1 wherein said external connector is a connector for electrical communication with tower service equipment.

4. The tractor trailer of claim 2 and further comprising a tower service equipment connector on said trailer electrically communicating with said battery module.

5. The tractor trailer of claim 2 wherein said trailer has a front and rear and said dock connector is located at the rear of said trailer.

6. The tractor trailer of claim 3 wherein said trailer has opposed sides and said truck service equipment connector is located at a side of said trailer.

7. The tractor trailer of claim 1 further comprising a battery charger positioned on said trailer and electrically connected to said battery module.

8. The tractor trailer of claim 1 wherein said trailer has an underside and battery module is suspended at the underside of said trailer.

9. The tractor trailer of claim 2 further comprising a detector for detecting whether said dock inlet connector is connected with an external cable.

10. The tractor trailer of claim 3 further comprising a detector for detecting whether said tower service equipment connector is connected to an external cable for said tower service equipment.

11. A method of managing the battery power supply of a tractor trailer comprising a plug in hybrid or electric cab having an electric power system with a battery power supply and a trailer comprising:
mounting a battery module to the trailer;
connecting the battery module to the electric power system for the cab;
transferring power from the battery module to the electric power system of the cab to meet electric power requirements for transporting the trailer;
charging the battery module while the trailer is parked;
disconnecting the battery module from the electric power system for the cab; and
driving the cab away from the trailer by employing the battery power supply of the cab.

12. The method of claim 11 further comprising charging the battery module while the trailer is at a loading dock.

13. The method of claim 11 further comprising charging the battery module while said trailer is connected to electric tower service equipment.

14. The method of claim 11 further comprising selecting a battery module from a plurality of battery modules in accordance with the transport function of the trailer.

15. A method for supplying electrical power for an electric motor for driving a plug in hybrid or electric tractor trailer comprising a plug in hybrid or electric cab couplable to a trailer for transport comprising:
providing an electric motor in the cab for driving said cab and a first battery module in the cab for supplying power to said motor;
providing a second battery module in the trailer;
electrically connecting said second module with a controller for said electric motor; and
supplying electric power from said second battery module for powering said electric motor.

16. The method of claim 15 wherein said step of electrically connecting said second module with a controller further comprises connecting a power cable from said second module with a connector on said cab.

17. The method of claim 16 further comprising:
electrically disconnecting said power cable from said connector;
decoupling said trailer from said cab; and
driving said cab away from said trailer.

18. The method of claim 14 further comprising:
providing a battery charger for charging said second battery module;
connecting said charger to an external connector;
connecting a power cable with said external connector; and
supplying power through said connector to charge said second battery module.

19. The method of claim 18 further comprising detecting connecting said power cable with said external connector and generating a signal indicative thereof.

20. The method of claim 15 further comprising selecting said second battery module from a plurality of battery modules with different capacities in accordance with the transport function of the trailer.
